(19) United States
(12) Patent Application Publication
(10) Pub. No.: US 2002/0178643 A1
(43) Pub. Date: Dec. 5, 2002

(54) Fishing lure

(76) Inventor: David Brodeur, Berlin, NH (US)

Correspondence Address: Michael J. Persson, Lawson, Philpot & Persson, P.C., 67 Water Street, Suite 110, Laconia, NH, 03246, US

(21) Appl. No.: 09/871,275

(22) Filed: May 31, 2001

(51) Int. Cl. A01K 85/00

(52) U.S. Cl. 43/42

(57) ABSTRACT

An artificial fishing lure that includes an elongate body manufactured of a substantially reflective material. The body has a length, a width that is substantially smaller than the length, a first surface and a second surface. The body includes a head portion, a tail portion and a central portion disposed between the head portion and the tail portion. The head portion of the body forms a first radius along the width and includes an opening disposed therethrough to allow the fishing lure to be attached to a fishing line. The tail portion of the body forms a second radius along the width and is attached to at least one hook and the central portion of the body is disposed at a third radius relative to the head portion along the length and at a fourth radius relative to the tail portion along the length.

### FIELD OF THE INVENTION

The present invention relates to the field of fishing lures and, in particular, to artificial fishing lures that imitate bait fish such as smelt, shiners or the like.

### BACKGROUND OF THE INVENTION

For time immemorial, people have engaged in the art of angling. In their quest to outsmart their quarry, fishermen have resorted to many different forms of bait. This accumulation of centuries of experimentation has provided today's fishermen with numerous choices for what to tie to the end of their line.

Live bait has traditionally been one of the most effective types of bait as it naturally has the appearance and action of what fish normally eat. When fishing for freshwater game fish commonly found in the northeastern Untied States, such as salmon, lake trout, rainbow trout, brown trout, and the like, live smelt, shiners, minnows, dace, or other indigenous species of bait fish are most effective. This is especially true when these fish are concentrated into schools during annual runs.

Despite their effectiveness, the use of live bait has a number of drawbacks. First, live bait is relatively expensive. For example, it currently costs between $4.00 and $8.00 per dozen for medium live smelt, with higher prices charged for larger species of shiners and minnows. Second, live bait are only effective for so long as they are alive. This is problematic as they are often killed by the insertion of the hook and/or sent into shock by the differences in temperature between the water in a bait pool or bucket and the temperature of the water being fished. Further, they will often die if kept in unaerated water for more than a day, meaning the they generally must be purchased, or caught with a dip net, within a few hours of the time that they are to be used. Third, live bait have a tendency to come off of the hook, either through casting, or through game fish strikes. Finally, live bait is not very effective when trolled behind a boat, as the movement of the boat causes the fish to be dragged through the water rather than producing a natural swimming motion. As trolling is an effective means for locating game fish that are cruising for food, this drawback is especially significant.

A number of types of artificial bait have been developed in order to overcome these drawbacks. One such type is the streamer fly. A streamer fly typically includes a single hook, or a tandem rig including two or more hooks, that is sized to correspond to the size of a particular baitfish and is adorned with a variety of feathers and other materials to simulate the appearance of a particular baitfish or group of baitfish. In the salmon and trout lakes and rivers of northern New England, it is common for streamer flies to imitate smelt and dace, which are a favorite food of landlocked salmon. These streamers take many forms, with the more popular types including the Grey Ghost, Winnepesaukee Smelt, Kennebago Smelt, Governor Aiken, and Black Nosed Dace.

Streamer flies overcome many of the drawbacks of live bait, as they may be used and reused without loss of effectiveness and produce a smoother action than live bait when trolled behind a boat. However, streamer flies also suffer from a number of drawbacks. First, though streamer flies appear more realistic than live bait when trolled behind a boat, they do not typically produce a sufficient swimming motion to truly imitate their live counterparts. Second, the materials making up streamer flies do not typically reflect light sufficient to produce a “flash” that will attract the attention of the fish. Finally, although more resilient than live bait, the feathers and other materials that adorn such flies are prone both to fouling and destruction when a large fish is caught.

Other commonly used types of artificial bait are spoons. Spoons come in many sizes, colors and textures and generally take their name from their resemblance to the head portion of a typical tea spoon or table spoons. Like streamer flies, spoons are readily reusable and are produce a better action than live bait when trolled. In addition, spoons are typically formed of metal, making them more resilient than flies, and may be textured to produce a “flash” in order to attract a game fish.

Despite these advantages, prior art spoons also suffer from significant drawbacks. First, the spoon-like shape of typical spoons does not effectively imitate baitfish, such as smelt, dace or minnows, which are indigenous to northeastern lakes. Second, the action produced by most spoons does not effectively imitate the natural swimming motion of live bait fish, but rather produces a spinning motion that acts primarily as a means for providing the attraction produced by their “flash” in order to induce strikes. Finally, even those spoons that are adapted to produce a more natural action are optimized for a relatively narrow range of trolling speeds, again limiting their effectiveness.

Therefore, there is a need for a fishing lure that may be used again and again without degradation, that produces an attractive flash in order to induce strikes from game fish, that is dimensioned to imitate the size and shape of common baitfish, and that produces and action, when trolled at varying speeds, that imitates the natural swimming action of common baitfish.

### SUMMARY OF THE INVENTION

The present invention is an artificial fishing lure that overcomes the drawbacks of the prior art. In its most basic form, the fishing lure includes an elongate body that is manufactured of a substantially reflective material. The body having a length, a width that is substantially smaller than the length, a first surface and a second surface. The body includes a head portion, a tail portion and a central portion disposed between the head portion and the tail portion. The head portion of the body forms a first radius along the width and includes an opening disposed therethrough to allow the fishing lure to be attached to a fishing line. The tail portion of the body forms a second radius along the width and is attached to at least one hook. Finally, the central portion of the body is disposed at a third radius relative to the head portion along the length and at a fourth radius relative to the tail portion along the length.

In operation, the fishing lure is attached to the fishing line via a swivel, which allows the lure to swim freely without twisting the line or having the line affect the action of the lure. The lure is then worked, either by trolling or by casting and reeling, at a speed of between about 1.5 and about 3 miles per hour. When worked at these speeds, the third radius and fourth radius of the body interact with the water to produce the appearance of a swimming bait fish.

The head and tail portions of the preferred fishing lure terminate in substantially rounded ends. In this preferred embodiment, the width of the body increases incrementally from the head portion to the tail portion. In some embodiments, the width of the body at the tail portion is between fifty percent and seventy five percent larger than the width of the body at the head portion, with the width of the body at the tail portion that is substantially two thirds larger than the width of the body at the head portion being preferred. In embodiments of the fishing lure designed to imitate smelt, it is preferred that that width of the body at the tail portion is about 0.3 inches and the width of the body at the head portion is about 0.2 inches.

The preferred fishing lure is rounded across its width, with different portions of the lure being rounded at different radii. In some embodiments, this rounding results in a first radius that is between one hundred and forty percent and one hundred and eighty percent of the width of the body at the head portion and a second radius that is between two hundred percent and three hundred percent of the width of the body at the tail portion. In embodiments of the fishing lure designed to imitate smelt, it is preferred that that the first radius be about 0.3 inches and the second radius be about 0.75 inches.

As noted above, the interaction of the third radius and the fourth radius with the water produce the desired action of the fishing lure. In some embodiments, the third radius is between eighty percent and one hundred and twenty percent of the length and wherein the fourth radius is between forty and sixty percent of the length. In the preferred embodiment, the third radius is between one hundred percent and one hundred and ten percent of the length and the fourth radius is between fifty and sixty percent of the length. In embodiments of the fishing lure designed to imitate smelt, it is preferred that that the length be about 2.6 inches, the third radius be about 2.8 inches, and the fourth radius be about 1.4 inches.

In order to more effectively imitate baitfish, a number of different patterns and details may be added to the first and/or second surfaces of the lure. These patterns and details may be stamped or otherwise formed into the surfaces, may be stickers applied to the surfaces, or may be painted or otherwise coated upon the surfaces.

In some embodiments, a scale pattern is formed into at least one of the first surface and the second surface. This scale pattern may take many forms, but is preferably made up of plurality of substantially circular shapes that are stamped into one or more of the surfaces. In other embodiments, the fishing lure also includes at least one eye disposed upon the head portion the first and/or second surfaces. Such an eye is preferably in the form of a sticker applied to the first surface. In still other embodiments, at least one colored stripe disposed along the length of at least one of the first and second surfaces. While in the preferred embodiment, a scale pattern, eye, and colored strip are all disposed upon the first surface of the body.

It is an aspect of the invention to provide a fishing lure that may be used again and again without degradation,

It is an aspect of the invention to provide a fishing lure that produces an attractive flash in order to induce strikes from game fish.

It is an aspect of the invention to provide a fishing lure that is dimensioned to imitate the size and shape of common baitfish.

It is an aspect of the invention to provide a fishing lure that produces and action that imitates the natural swimming action of common baitfish.

It is a still further aspect of the invention to provide a fishing lure that may be trolled at varying speeds without substantially degrading the action of the lure.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a top view of one embodiment of the body of the fishing lure of the present invention.

FIG. 2 is a section view of one embodiment of the body of the fishing lure of the present invention taken along section A-A of FIG. 1.

FIG. 3 is a section view of one embodiment of the body of the fishing lure of the present invention taken along section B-B of FIG. 1.

FIG. 4 is a side view of one embodiment of the body of the fishing lure of the present invention.

FIG. 5 is a side view of the body of the fishing lure attached to a fishing line with phantom lines showing the action created by the movement of the tail portion of the body.

FIG. 6 is a top view of the preferred embodiment of the fishing lure of the present invention showing invention-showing eye and colored stripe details.

### DETAILED DESCRIPTION OF THE INVENTION

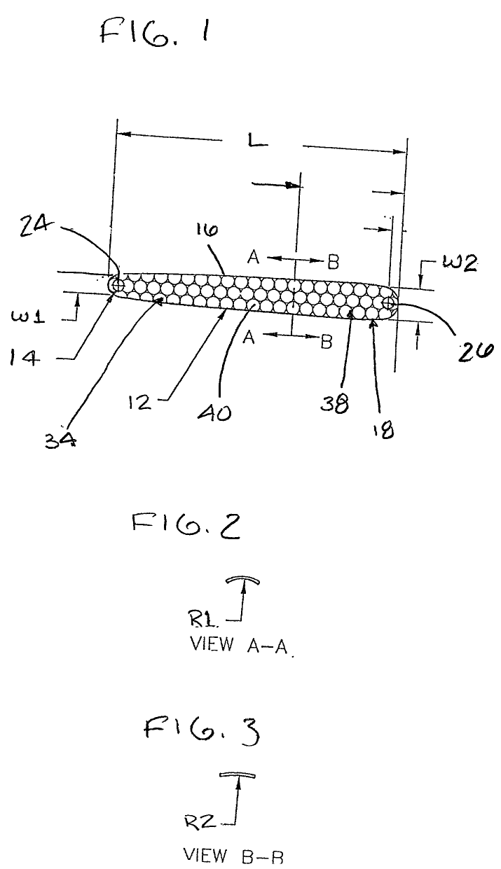

Referring first to FIGS. 1-4, one embodiment of the body 12 of the fishing lure 10 of the present invention is shown. The body 12 has an elongate shape and is manufactured of a substantially reflective material. In the preferred embodiment, this material is 201 stainless steel having a thickness T of 0.025 inches. However, in other embodiments it many be manufactured of other commonly utilized fishing lure materials, such as brass, bronze, plated steel, aluminum, or the like, provided that the material has sufficient reflective properties to provide an attractive flash when hit by light within the water.

The body 12 is divided along its length L into three portions; a head portion 14, a tail portion 18 and a central portion 16 disposed between the head portion 14 and the tail portion 14. The body 12 also has a width that is substantially smaller than the length L. As shown in FIG. 1, this width preferably increases from a first width WI at the head portion 14 to a second width W2 at the tail portion 18. In some embodiments, the second width W2 is between fifty percent (50%) and seventy-five percent (75%) larger than the first width W1. In the preferred embodiment, the second width W2 is substantially two thirds (66.67%) larger than the first width W1. In embodiments of the fishing lure 10 designed to imitate smelt, it is preferred that that second width W2 of the body 12 be about 0.3 inches and the first width W1 of the body 12 be about 0.2 inches.

The length L and width W1 and W2 of early embodiments of the fishing lure were chosen to exactly imitate the dimensions of a live smelt, which is wider at its midsection than at its ends. However, it was found that dimensioning the lure 10 to tapers gradually from the head portion 14 to the tail portion 18 caused the lure 10 to have a more realistic swimming action. Therefore, these dimensions are preferred.

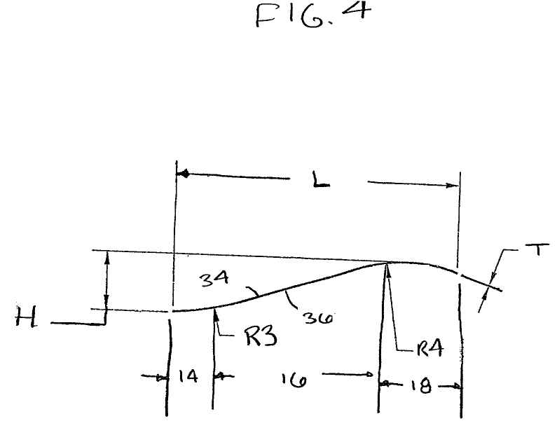

The preferred fishing lure 10 is rounded across its width, with different portions of the lure 10 being rounded at different radii. As shown in FIGS. 2 and 3, the head portion 14 of the body 12 forms a first radius R1 across the width W1 and the tail portion 18 forms a second radius R2 across the width W2. In some embodiments, this rounding results in a first radius R1 that is between one hundred and forty percent (140%) and one hundred and eighty percent (180%) of the first width W1 of the body 12 and a second radius R2 that is between two hundred percent (200%) and three hundred percent (300%) of the second width W2. In embodiments of the fishing lure 10 designed to imitate smelt, it is preferred that that the first radius R1 be about 0.3 inches and the second radius R2 be about 0.75 inches.

The head portion 14 and tail portion 14 of the preferred fishing lure 10 terminate in substantially rounded ends 20, 22 and openings 24, 26 are disposed proximate to each of these ends 20, 22. The opening 24 in the head portion 14 is dimensioned allow the fishing lure 10 to be attached to a fishing line (not shown), while the opening 26 in the tail portion 18 is dimensioned to allow the hook 48 (shown in FIG. 6) to be attached to the lure 10. In the preferred embodiment, these openings 24, 26 are approximately 0.125 inches in diameter. However, other embodiments may utilize larger or smaller openings 24, 26 dependent upon the size of the hook and/or swivel that is to be attached to the body. In the preferred embodiment, the opening 24 is dimensioned to allow a split ring (not shown) to be secured in such as way as to allow the lure 10 to swing back and forth when it is used.

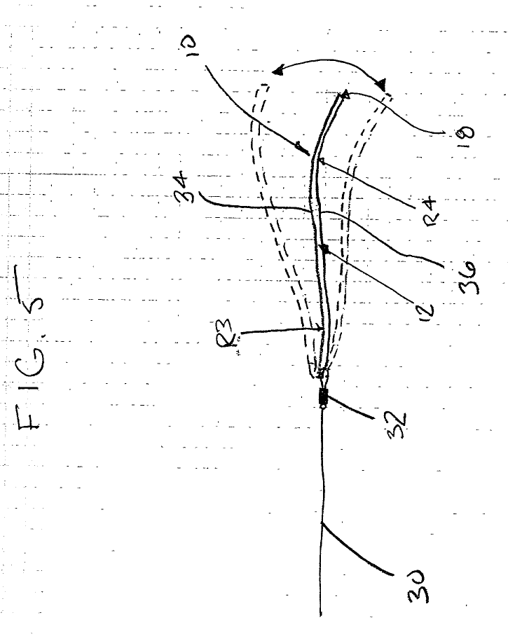

As shown more clearly in FIG. 4, the central portion 16 is defined by the tangent of the third radius R3 and the tangent of the fourth radius R4. The difference in height H between these tangents is preferably about three times the first width W1, with embodiments in which a smelt is imitated having a height H of about 0.563 inches. The third radius R3 and the fourth radius R4 are dimensioned to produce the desired action when the lure 10 is trolled or retrieved. In some embodiments, the third radius R3 is between eighty percent (80%) and one hundred and twenty percent (120%) of the length L, and the fourth radius R4 is between forty percent (40%) and sixty percent (60%) of the length L. In the preferred embodiment, the third radius R3 is between one hundred percent (100%) and one hundred and ten percent (110%) of the length L and the fourth radius R4 is between fifty percent (50%) and sixty percent (60%) of the length L. In embodiments of the fishing lure 10 designed to imitate smelt, it is preferred that that the length L be about 2.6 inches, the third radius R3 be about 2.8 inches, and the fourth radius R4 be about 1.4 inches.

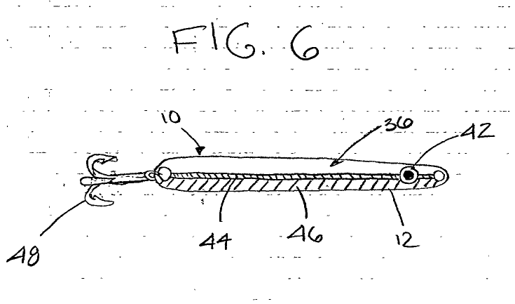

The third radius R3 and fourth radius R4 are dimensioned to provide the desired action of the lure, with the third radius R3 starting the lure to one side and the fourth radius R4 pushing it back to the other side. This action is demonstrated by FIG. 5, which shows the fishing lure 10 is attached to the fishing line 30 via a swivel 32. It is noted that the use of a swivel 32allows the lure 10 to swim freely without twisting the line 30 or having the line 30 affect the action of the lure 10, but is not required. The lure 10 is worked, either by trolling or by casting and reeling, at a speed of between about 1.5 and about 3 miles per hour. When worked at these speeds, the third radius R3 and fourth radius R4 of the body 12 interact with the water and cause the tail portion 18 of the body 12 to swing back and forth. This action is demonstrated by the dashed lines in FIG. 5 and produces the appearance of a swimming baitfish.

Although FIG. 5 shows the lure 10 being trolled, the lure 10 may also be jigged off of the bottom of the body of water to induce strikes. Similarly, it may be attached behind a dodger (not shown), which caused the lure 10 to be pulled back and forth at varying speeds during trolling, rigged with downriggers, or fished in any other manner commonly used to catch gamefish.

In order to more effectively imitate baitfish, a number of different patterns and details may be added to the first surface 34 and/or second surface 36 of the lure 10. As shown in FIG. 1, some embodiments gave a scale pattern 38, which is formed into first surface 34 of the lure. This scale pattern 38 may take many forms, but is preferably made up of plurality of substantially circular shapes 40 that are disposed in interstitial relationship with one another. In other embodiments, however, the pattern may consist of a plurality of rectangular, triangular, octagonal, or non-polygonal shapes, which are intended both to imitate the scales commonly found on bait fish and to enhance the flash produced by the lure. In still other embodiments, the scale pattern 38 is eliminated.

In other embodiments, such as that shown in FIG. 6, the fishing lure includes at least one eye 42 disposed upon the head portion 18 of the first surface 34 and/or the second surface 36 of the lure 10. Such an eye 42 is preferably in the form of a sticker applied to the first surface 34, although such an eye 42 may be painted upon the surface or formed using other art recognized techniques. The embodiment of FIG. 6 also includes a pair of colored stripes 44, 46 that are disposed along the length L of the first surface 34 and/or the second surface 36 of the lure 10. As was the case with the eye 42, the stripes 44, 46 are preferably in the form of a sticker or stickers that are affixed to the lure, although it is recognized that they could be painted, died or otherwise affixed using art recognized techniques. The preferred sticker is manufactured by Witchcraft Tape Products and includes a holographic impression that enhances the appearance to the lure 10 by imitating scales. These stickers come in a variety of colors, including glue, green, orange, copper, pink, chartreuse, and with a number of different patterns.

Finally, although the embodiment of FIG. 6 does not include a scale pattern, it is recognized that such a pattern is combined with the eye 42, colored stripes 44, 46 or any variation thereof could be utilized. Further, although the stripes have been shown as being disposed along the lateral line of the body 12, the entire first surface 34 and/or second surface 36 may be colored.

The fishing lure 10 of the present invention is readily manufactured using art recognized techniques. Currently, the inventor's preferred method of manufacturing the body 12 involves the steps of cutting a blank from a piece metal by hand using a bandsaw, drilling the openings 24, 26 in the appropriate locations, and bending the various radii R1-R4 using a hydraulic press and a variety of simple single station dies. In embodiments in which a scaling pattern is formed, a scaling die, or scaling dies, are mounted within the hydraulic press and act to dispose the desired pattern on the surface, or surfaces of the body 12 of the lure 10. However, it is recognized that this process could readily be automated using industry standard equipment to allow the body 12 of the lure 10 to be mass produced.

Once the body 12 has been formed, the hook 48 is attached and, if desired, a ring is mounted through the opening 24 in the head portion 14 of the body 12 to aid in attaching the lure 10 to a swivel. If desired, the eye 42 and any stripes 44, 46 are then affixed to the lure 12 and allowed to dry, after which the lure 10 is ready for use.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. An artificial fishing lure comprising:
an elongate body manufactured of a substantially reflective material, said body having a length, a width that is substantially smaller than said length, a first surface and a second surface, said body further comprising;
a head portion that forms a first radius along the width, said head portion having an opening disposed therethrough that is dimensioned to allow said fishing lure to be attached to a fishing line;
a tail portion that forms a second radius along the width; and
a central portion disposed between said head portion and said tail portion, wherein said central portion is disposed at a third radius relative to said head portion along said length and at a fourth radius relative to said tail portion along said length; and
at least one hook attached to said tail portion of said body.

2. The fishing lure as claimed in claim 1 wherein said head portion terminates a first substantially rounded end and said tail portion terminate in a second substantially rounded end.

3. The fishing lure as claimed in claim 2 wherein said width of said body increases incrementally from said head portion to said tail portion.

4. The fishing lure as claimed in claim 3 wherein said width of said body at said tail portion is between fifty percent and seventy five percent larger than said width of said body at said head portion.

5. The fishing lure as claimed in claim 4 wherein said width of said body at said tail portion is substantially two thirds larger than said width of said body at said head portion.

6. The fishing lure as claimed in claim 5 wherein said width of said body at said tail portion is about 0.3 inches and said width of said body at said head portion is about 0.2 inches.

7. The fishing lure as claimed in claim 4 wherein said first radius is between one hundred and forty percent and one hundred and eighty percent of said width of said body at said head portion and wherein said second radius is between two hundred percent and three hundred percent of said width of said body at said tail portion.

8. The fishing lure as claimed in claim 5 wherein said first radius is about 0.3 inches and said second radius is about 0.75 inches.

9. The fishing lure as claimed in claim 2 wherein said third radius is between eighty percent and one hundred and twenty percent of said length and wherein said fourth radius is between forty and sixty percent of said length.

10. The fishing lure as claimed in claim 9 wherein said third radius is between one hundred percent and one hundred and ten percent of said length and wherein said fourth radius is between fifty and sixty percent of said length.

11. The fishing lure as claimed in claim 8 wherein said length is about 2.6 inches, said third radius is about 2.8 inches, and said fourth radius is about 1.4 inches.

12. The fishing lure as claimed in claim 2 wherein said body further comprises a scale pattern formed into at least one of said first surface and said second surface.

13. The fishing lure as claimed in claim 12 wherein said scale pattern comprises a plurality of substantially circular shapes.

14. The fishing lure as claimed in claim 2 wherein said body further comprises an eye disposed upon said head portion of at least one of said first and second surfaces.

15. The fishing lure as claimed in claim 14 wherein said body further comprises at least one colored stripe disposed along said length of at least one of said first and second surfaces.

16. The fishing lure as claimed in claim 2 wherein said body further comprises at least one colored stripe disposed along said length of at least one of said first and second surfaces.
